(19) United States
(12) Patent Application Publication
(10) Pub. No.: US 2016/0203419 A1
(43) Pub. Date: Jul. 14, 2016

(54) METAHEURISTIC-GUIDED TRUST-TECH METHODS FOR GLOBAL UNCONSTRAINED OPTIMIZATION

(71) Applicant: Bigwood Technology, Inc., Ithaca, NY (US)

(72) Inventors: Hsiao-Dong Chiang, Ithaca, NY (US); Yong-Fong Zhang, Jinan (CN)

(21) Appl. No.: 15/081,027

(22) Filed: Mar. 25, 2016

Related U.S. Application Data
(63) Continuation-in-part of application No. 13/791,982, filed on Mar. 9, 2013, now abandoned.

(51) Int. Cl. G06N 99/00; G06N 3/08; G06N 7/00; G06F 17/30; G06N 3/12

(52) U.S. Cl. CPC G06N 99/005; G06F 17/30598; G06N 3/126; G06N 7/00; G06N 3/084

(57) ABSTRACT

A method determines a global optimal solution of a system defined by a plurality of nonlinear equations by applying a metaheuristic method to cluster a plurality of search instances into at least one group, selecting a center point and a plurality of top points from the search instances in each group and applying a local method, starting from the center point and top points for each group, to find a local optimal solution for each group in a tier-by-tier manner. Then a TRUST-TECH methodology is applied to each local optimal solution to find a set of tier-1 local optimal solutions, and the TRUST-TECH methodology is applied to each tier-1 local optimal solution to find a set of tier-2 local optimal solutions. A best solution is identified among all the local optimal solutions as the global optimal solution. The heuristic method can be a particle swarm optimization method or a genetic algorithm method.

### REFERENCE TO RELATED APPLICATIONS

This is a continuation-in-part of co-pending patent application Ser. No. 13/791,982, entitled “PSO-GUIDED TRUST-TECH METHODS FOR GLOBAL UNCONSTRAINED OPTIMIZATION”, which was filed Mar. 9, 2013. The aforementioned application is hereby incorporated herein by reference.

### BACKGROUND OF THE INVENTION

1. Field of the Invention

The invention pertains to the field of modeling and optimization. More particularly, the invention pertains to methods for solving nonlinear optimization problems. Practical applications include finding optimal power flow in smart grids and short-term load forecasting systems.

2. Description of Related Art

Optimization technology has practical applications in almost every branch of science, business, and technology. Indeed, a large variety of quantitative issues such as decision, design, operation, planning, and scheduling can be perceived and modeled as either continuous or discrete nonlinear optimization problems. These problems are bounded in practical systems arising in the sciences, engineering, and economics. Typically, the overall performance (or measure) of a system can be described by a multivariate function, called the objective function. According to this generic description, one seeks the best solution of a nonlinear optimization problem, often expressed by a real vector, in the solution space that satisfies all stated feasibility constraints and minimizes (or maximizes) the value of an objective function. The vector, if it exists, is termed the global optimal solution.

The process of finding the global optimal solution, namely, the process of global optimization, has many industrial applications in different areas. The optimal power flow (OPF) problem in electric power systems is one example, where the target is to minimize the system total production cost or the system total power losses, and the decision variables are quantities associated with the devices of the power network that can be adjusted, such as the power outputs by generators, the voltage settings at system nodes, the amount of shunt capacitors deployed, and the tap positions of transformers. A tank design for a multi-product plant in chemical engineering is another example, where the target is to minimize the sum of the production cost per ton per product produced and the decision variables are quantities of products. As yet another example in the power industry, training artificial neural networks (ANN) to forecast system power demands, the inter-area interchanged energy, and renewable energy (wind, solar, biomass, etc.) generation, where the target is to minimize the differences between the outputs produced by the ANN and the actual quantities, and the decision variables are the structure of the ANN (i.e., the number of layers and the number of nodes at different layers) and its connection weights.

For practical applications, the underlying objective functions are often nonlinear and depend on a large number of variables. This makes the task of searching the solution space for the global optimal solution very challenging. The primary challenge is that, in addition to the high dimensionality of the solution space, there are many local optimal solutions in the solution space where a local optimal solution is optimal in a local region of the solution space, but not the global solution space. The global optimal solution is just one solution and yet, both the global optimal solution and local optimal solutions share the same local properties. In general, the number of local optimal solutions is unknown and can be quite large. Furthermore, the objective function values at the local optimal solutions and the global optimal solution may differ significantly. Hence, there are strong motivations to develop effective methods for finding the global optimal solution.

One popular method for solving nonlinear optimization problems is to use an iterative local improvement search procedure, which can be described as follows: start from an initial vector and search for a better solution in its neighborhood. If an improved solution is found, repeat the search procedure using the new solution as the initial point; otherwise, the search procedure will be terminated. However, such local improvement search methods usually get trapped at local optimal solutions and are unable to escape from these local optimal solutions. In fact, a great majority of existing nonlinear optimization methods for solving optimization problems produce only local optimal solutions but not the global optimal solution. Some popular local methods include Newton's method, the Quasi-Newton method, the trust-region search method, the quadratic programming method, and the interior point method.

The drawback of iterative local improvement search methods has motivated the development of more sophisticated local search methods designed to find better solutions via introducing special mechanisms that allow the search process to escape from local optimal solutions. The underlying “escaping” mechanisms use certain search strategies, accepting a cost-deteriorating neighborhood to make an escape from a local optimal solution possible. These sophisticated global search methods, which are also called metaheuristic methods, include simulated annealing, genetic algorithm, Tabu search, evolutionary programming, and particle swarm operator methods. However, these sophisticated global search methods require intensive computational effort and usually, still cannot find the globally optimal solution.

In the present invention, two popular metaheuristic methods, namely, the particle swarm optimization (PSO) method and the genetic algorithm (GA), are of special interest. It needs to be mentioned that the methods presented in this invention are also applicable to other metaheuristic methods, such as simulated annealing, the genetic algorithm, Tabu search, evolutionary programming, and differential evolution.

Particle swarm optimization (PSO) is a metaheuristic evolutionary computation technique developed by Eberhart and Kennedy (“Particle swarm optimization”, Proceedings IEEE International Conference on Neural Networks, Piscataway, N.J., pp. 1942-1948, 1995). This technique is a form of swarm intelligence in which the behavior of a biological social system, like a flock of birds, is simulated. Particle Swarm Optimization (PSO) methods play an important role in solving nonlinear optimization problems. Significant R&D efforts have been spent on PSOs and several variations of PSOs have been developed. However, PSO has several drawbacks in searching for the global optimal solution. One drawback, which is common to other stochastic search methods, is that PSO is not guaranteed to converge to the global optimal solution and can easily converge to a local optimal solution. Another drawback is that PSO is computationally demanding and has slow convergence rates.

The genetic algorithm (GA) is another search metaheuristic that mimics the process of natural evolution and is used to generate useful solutions to optimization and search problems (see, for example, Mitchell, An Introduction to Genetic Algorithms, MIT Press, Cambridge, Mass., 1996). The algorithm repeatedly modifies a population of individual solutions. At each step, the genetic algorithm randomly selects individuals, or search instances, from the current population and uses them as parents to produce the offspring for the next generation. Over successive generations, the population evolves toward an optimal solution. GA exploits historical information to direct the search into the region of better performance (better fitness) within the search space. It follows the principles of “survival of the fittest” in nature, that competition among individuals, or search instances, for scanty resources results in the fittest individuals dominating over the weaker ones.

The term TRUST-TECH used herein is an acronym for “TRansformation Under STability-reTaining Equilibria Characterization”. The TRUST-TECH methodology is a dynamical method for obtaining a set of local optimal solutions of general optimization problems, including the steps of first finding, in a deterministic manner, one local optimal solution starting from an initial point, and then finding another local optimal solution starting from the previously found one until all of the local optimal solutions are found, and then finding the global optimal solution from the local optimal solutions.

Wang and Chiang (“ELITE: Ensemble of Optimal Input-Pruned Neural Networks Using TRUST-TECH”, IEEE Transactions on Neural Networks, Vol. 22, pp. 96-109, 2011) disclose an ensemble of optimal input-pruned neural networks using a TRUST-TECH (ELITE) method for constructing a high-quality ensemble through an optimal linear combination of accurate and diverse neural networks.

Lee and Chiang (“A dynamical trajectory-based methodology for systematically computing multiple optimal solutions of general nonlinear programming problems”, IEEE Transactions on Automatic Control, Vol. 49, pp. 888-899, 2004) disclose a dynamical trajectory-based methodology for systematically computing multiple local optimal solutions of general nonlinear programming problems with disconnected feasible components satisfying nonlinear equality/inequality constraints.

In the above-cited 2004 Lee and Chiang paper, the TRUST-TECH method for finding, starting from a local optimal solution, a set of local optimal solutions is described as follows, which is shown in the flowchart of FIG. 12A:
Step 140: Starting from a local optimal solution, move along a (given or desired) direction to find the corresponding dynamic decomposition point of the associated gradient system.
Step 142: Starting from the dynamic decomposition point, move along the unstable manifold of the decomposition point until a point close to another local optimal solution.
Step 144: Apply a local optimization method starting from the point to locate another local optimal solution.

Another version of the TRUST-TECH method for finding, starting from a local optimal solution, a set of local optimal solutions, also set out in the 2004 paper, is described as follows, which is shown in the flowchart of FIG. 12B:
Step 146: Starting from a local optimal solution, move along a (given or desired) direction to find the exit point of the associated gradient system.
Step 148: Starting from the exit point, move one step further along the direction, and integrate the trajectory of the associated gradient system until the trajectory until a point close to another local optimal solution.
Step 150: Apply a local optimization method starting from the point to locate another local optimal solution.

Note: Given a local optimal solution of a general unconstrained continuous optimization problem (i.e., a stable equilibrium point (SEP) of the associated nonlinear dynamical system and a predefined search path starting from the SEP, we describe a method for computing the exit point of the nonlinear dynamic system associated with the optimization problem.

The method is as follows: starting from a known local optimal solution, say xs, move along a predefined search path to compute said exit point, which is the first local maximum of the objective function of the optimization problem along the predefined search path.

Chiang and Chu (“Systematic search method for obtaining multiple local optimal solutions of nonlinear programming problems”, IEEE Transactions on Circuits and Systems I: Fundamental Theory and Applications, Vol. 13, pp. 99-109, 1996) disclose systematic methods to find several local optimal solutions for general nonlinear optimization problems.

All of the above-mentioned references are hereby incorporated by reference herein.

### SUMMARY OF THE INVENTION

A method determines a global optimal solution of a system defined by a plurality of nonlinear equations. The method includes the first stage of applying a metaheuristic method to cluster a plurality of search instances into at least one group or “promising region” for the plurality of nonlinear equations. The method also includes the second stage of selecting a center point and a plurality of top points from the search instances in each promising region and applying a local method, starting from the center point and top points for each group, to find a local optimal solution for each group in a tier-by-tier manner. The method further includes the third stage of applying a TRUST-TECH methodology to each local optimal solution to find a set of tier-1 optimal solutions and identifying a best solution among the local optimal solutions and the tier-1 optimal solutions as the global optimal solution. The method further includes applying a TRUST-TECH methodology to each tier-1 optimal solution to find a set of tier-2 optimal solutions and identifying a best solution among the local optimal solutions and the tier-1 and tier-2 optimal solutions as the global optimal solution. In some embodiments, the metaheuristic method is a particle swarm optimization methodology. In other embodiments, the metaheuristic method is a genetic algorithm methodology.

### BRIEF DESCRIPTION OF THE DRAWING

FIG. 1 shows three steps involved in the metaheuristic-guided TRUST-TECH procedure.

FIG. 2 shows three steps involved in the metaheuristic-guided TRUST-TECH procedure.

FIG. 3 shows a flowchart in the first stage of a method of the present invention.

FIG. 4 shows schematically the first stage of a method of the present invention.

FIG. 5 shows a flowchart in the second-stage of a method of the present invention.

FIG. 6 shows schematically the second stage of a method of the present invention.

FIG. 7 shows a flowchart in the third stage of a method of the present invention.

FIG. 8 shows schematically finding corresponding tier-1 local optimal solutions in the third stage of a method of the present invention.

FIG. 9 shows schematically finding corresponding tier-2 local optimal solutions in the third stage of a method of the present invention.

FIG. 10 shows the application of the present method to load forecasting.

FIG. 11 shows a block diagram of an environment for running the application of FIG. 10.

FIGS. 12A and 12B show flowcharts of the prior art TRUST-TECH method.

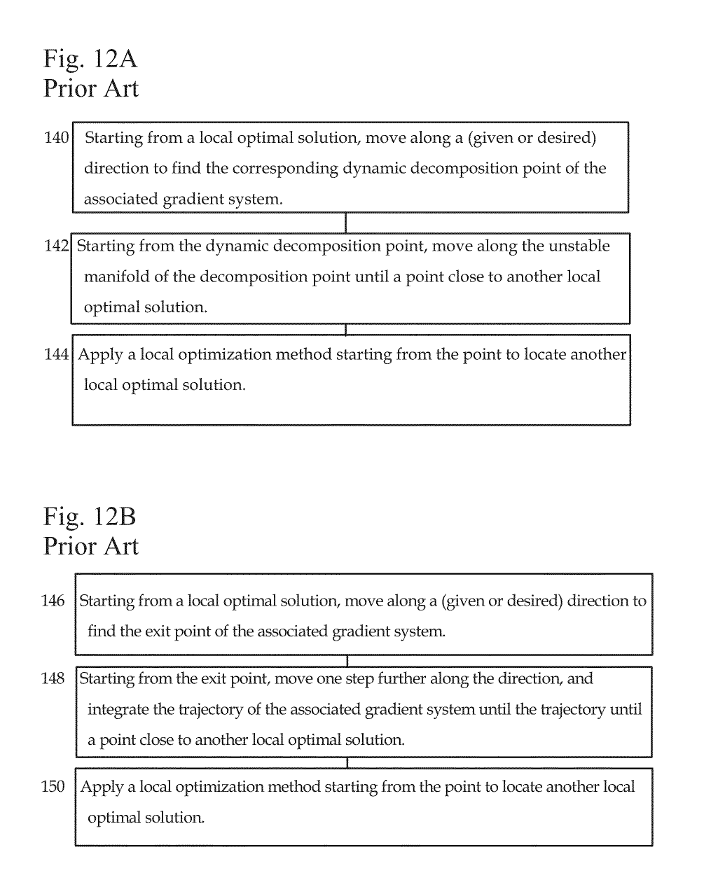

### DETAILED DESCRIPTION OF THE INVENTION

In some embodiments, to overcome the limitations of metaheuristic methods, the present methodology uses a metaheuristic-guided TRUST-TECH methodology, which is highly efficient and robust, to solve global unconstrained optimization problems. The methodology preferably has the following goals in mind:
1) The methodology is able to find high-quality local optimal solutions, and possibly (or highly likely), the global optimal solution.
2) The methodology only searches for a subset of the search space that contains high-quality local optimal solutions.
3) The methodology quickly obtains a set of high-quality optimal solutions.
4) The methodology obtains the set of high-quality optimal solutions in a tier-by-tier manner
5) It can obtain better solutions than metaheuristic methods in a shorter computation time.

In some embodiments, the present methods are automated. At least one computation of the present methods is performed by a computer. Preferably all of the computations in the present methods are performed by a computer. A computer, as used herein, may refer to any apparatus capable of automatically carrying out computations based on predetermined instructions in a predetermined code, including, but not limited to, a computer program.

In some embodiments, the present methods are executed by one or more computers following the program instructions of a computer program product on at least one computer-readable, tangible storage device. The computer-readable, tangible storage device may be any device readable by a computer within the spirit of the present invention.

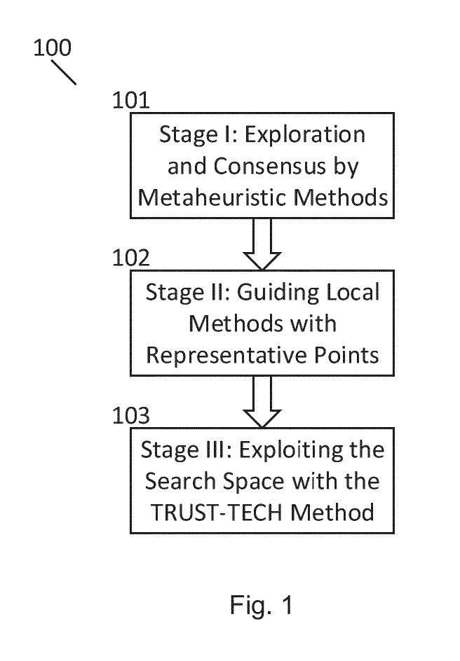

Referring to FIG. 1, this methodology 100 preferably includes three main stages described herein as stage I for exploration and consensus by metaheuristic methods 101, stage II for guiding local methods with representative points 102, and stage III for exploiting the search space with the TRUST-TECH method 103.

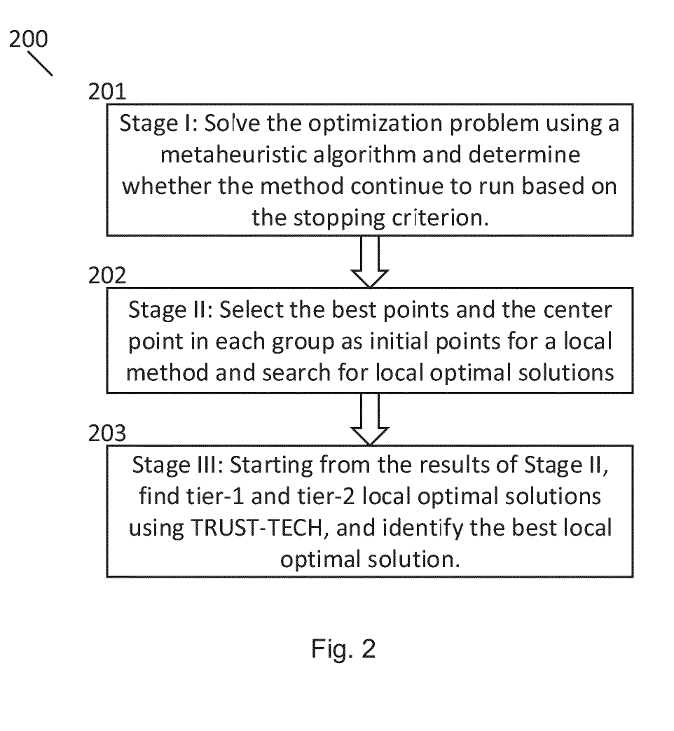

The present methods are efficient and robust methods for solving global unconstrained optimization problems. In one embodiment, the present methods are termed herein as metaheuristic-guided TRUST-TECH methods. Referring to FIG. 2, this methodology 200 preferably includes three main stages, described herein as stage I for solving the optimization problem using a metaheuristic method and determining whether the method continue to run based on the stopping criterion 201, stage II for selecting the best points and the center point in each group as initial points for a local method and searching for local optimal solutions 202, and stage III for, starting from the results of stage II, finding tier-1 and tier-2 local optimal solutions using TRUST-TECH and identifying the best local optimal solution 203.

The premises for the present methodology to find high-quality local optimal solutions preferably include the following:

1) All of the search instances of the metaheuristic method have reached a high level of consensus by forming several groups. Each group contains a number of instances (large or small) that lie close to each other in the search space.

2) Each group of instances reveals that high-quality local optimal solutions, even the global optimal solution, are located in the region ‘covered’ by the search instances and are close to the search instances.

3) From the high-quality local optimal solutions obtained by the metaheuristic method, the TRUST-TECH methodology effectively finds all of the tier-1 and tier-2 local optimal solutions located in the covered region of the search space.

4) The set of all the tier-0, tier-1, and tier-2 local optimal solutions obtained by the TRUST-TECH methodology contains a set of high-quality local optimal solutions or even the global optimal solution.

### The TRUST-TECH Methodology

The only reliable way to find the global optimal solution of an unconstrained optimization problem is to first find all the high-quality local optimal solutions and then, from them, find the global optimal solution. The TRUST-TECH methodology is a dynamical method for obtaining a set of local optimal solutions of general optimization problems that includes the steps of first finding, in a deterministic manner, one local optimal solution, starting from an initial point, and then finding another local optimal solution, starting from the previously found one until all the local optimal solutions are found, and then finding the global optimal solution from the local optimal solutions. The TRUST-TECH methodology framework is illustrated in solving the following unconstrained nonlinear programming problem.

Without loss of generality, an n-dimensional optimization problem can be formulated:

min_{xεR}_{ⁿ}C(x), (1)

where C(x): Rⁿ→R is a function bounded below and possesses only finite local optimal solutions. It is noted that maximization problems are also readily covered by (1) since

max_{xεR}_{ⁿ}C(x)

is equivalent to

min_{xεR}_{ⁿ}−C(x).

Therefore, only minimization will be considered in the following description of the optimization problem. A focus of solving this problem is to locate all or multiple local optimal solutions of C(x). The TRUST-TECH methodology solves this optimization problem by first defining a dynamical system:

\dot{x}(t)=−∇C(x),xεRⁿ. (2)

Moreover, the stable equilibrium points (SEPs) in the dynamical system (2) have one-to-one correspondence with local optimal solutions of the optimization problem (1). Because of this transformation and correspondence, we have the following results.

First, a local optimal solution of the optimization problem (1) corresponds to a stable equilibrium point of the gradient system (2).

Second, the search space for the optimization problem (1) of computing multiple local optimal solutions is then transformed to the union of the stability regions in the defined dynamical system, each of which contains only one distinct SEP.

Third, an SEP can be computed using a trajectory method or using a local method, with a trajectory point lying in its stability region as the initial point.

Finally, this transformation allows each local optimal solution of the problem (1) to be located via each stable equilibrium point of the gradient system (2).

The task of selecting proper search directions for locating another local optimal solution from a known local optimal solution of the unconstrained optimization problem in an efficient way is very challenging. Starting from a local optimal solution (i.e., an SEP), there are several possible search directions that may be chosen as a subset of dominant eigenvectors of the objective Hessian at the SEP. However, computing Hessian eigenvectors, even dominant ones, is computationally demanding, especially for large-scale problems. Another choice is to use random search directions, but they need to be orthogonal to each other to span the search space and maintain a diverse search. It appears that effective directions in general have a close relationship with the structure of the objective function (and the feasible set for constrained problems). Hence, exploitation of the structure of the objective under study proves fruitful in selecting search directions.

By exploring the TRUST-TECH methodology's capability of escaping from local optimal solutions in a systematic and deterministic way, it becomes feasible to locate multiple local optimal solutions in a tier-by-tier manner. As a result, multiple high-quality local optimal solutions are obtainable.

### Metaheuristic-Guided TRUST-TECH Methodology

According to the characteristics of the TRUST-TECH method and metaheuristic methods, the present methods are developed as a metaheuristic-guided TRUST-TECH methodology for solving general nonlinear optimization problems of the form (1). Referring to FIG. 1, this methodology 100 preferably includes three main stages, described herein as stage I for exploration and consensus by the metaheuristic method 101, stage II for guiding local methods with representative points 102, and stage III for exploiting the search space with the TRUST-TECH method 103.

### Stage I: Exploration and Consensus

The metaheuristic method preferably guides each search instance to promising regions that may contain the global optimal solution. However, since each search instance has different information regarding the location of the global optimal solution, these search instances hold different views of the location of the global optimal solution; therefore, all search instances may gather at several different regions of the search space. In other words, these search instances tend to form groups of instances as they progress. They preferably reach an “equilibrium state” for consensus that meets both of the following conditions, including 1) the number of groups of instances is not changing, and 2) the members in each group are not changing.

Different search instances will settle down in different locations, forming several different groups in the research space; therefore, the instances do not form only one group. In addition, it should be noted that the largest group, i.e., the group containing the greatest number of search instances, does not necessarily indicate the region with members of search instances that will settle down to the global optimal solution. In some cases, distinct search instances with outstanding performance move towards the region containing the global optimal solution.

In addition, the number of search instances in each group and the quality of the fitness value of each instance do not necessarily reveal information regarding the quality of local optimal solutions lying in the region. Consequently, the region in which each group of instances settles down is preferably exploited by the TRUST-TECH method in a tier-by-tier manner to obtain high-quality local optimal solutions. Therefore, all groups are preferably explored to make sure the global optimal solution is obtained.

To make the assistance more efficient, stage I clusters all of the search instances using effective supervised and unsupervised grouping schemes, such as an Iterative Self-Organizing Data Analysis Techniques Algorithm (ISODATA), to identify the groups after certain iterations. It should be noted that ISODATA is an unsupervised clustering method, and a user needs to provide threshold values to determine the number of groups and the members in each group. In view of the results of clustering, the stopping criterion (i.e., the consensus condition) of stage I is reached when all search instances have reached a consensus. If not, the metaheuristic process continues the exploration stage until the stopping criterion is met.

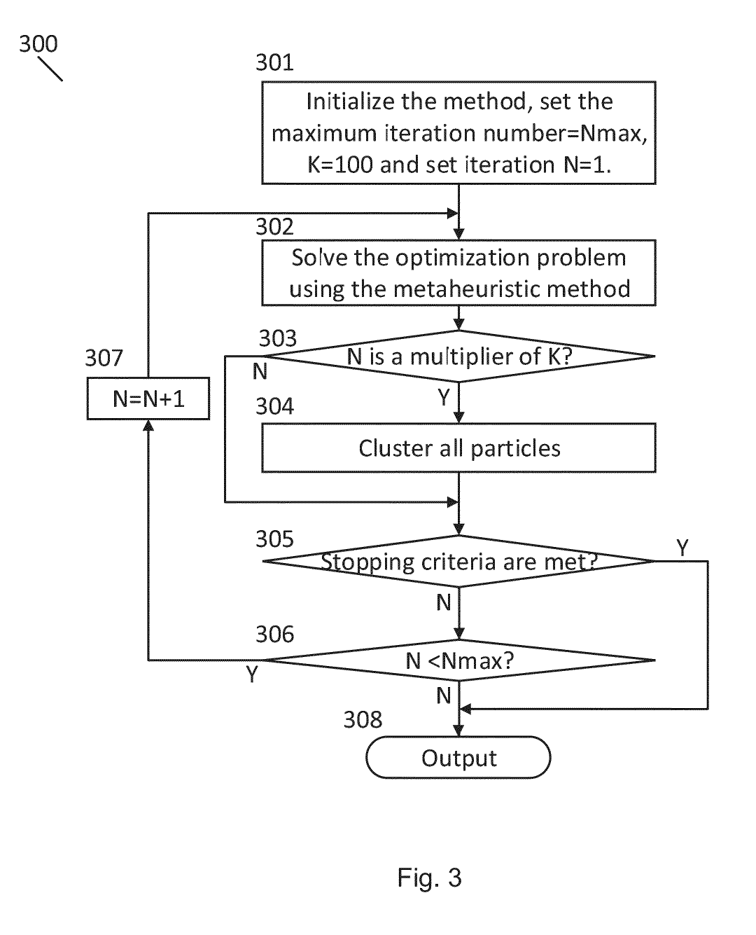

Referring to FIG. 3, a flowchart summarizes stage I for exploration and consensus. Stage I 300 of the method of the present invention comprises the following steps.
Step 1) The metaheuristic method is initialized by setting the maximum number of iterations, denoted as Nmax; the number of iterations, denoted as K, for consensus checking; and setting the iteration counter N=1 (block 301).
Step 2) Solve the optimization problem (1) using the metaheuristic method. More specifically, a single metaheuristic update is carried out (block 302).
Step 3) The iteration counter N is checked (block 303). If N is a multiplier of the consensus checking interval, K, then the search instances are clustered (304) and proceed to step 4; otherwise, proceed to step 4 directly.
Step 4) Check if the stopping criteria are met (block 305). The stopping criteria include: 1) the number of groups of search instances is not changed, and 2) the search instances in each group are not changed. If the stopping criteria are met, then proceed to step 5; otherwise, check if the metaheuristic iteration counter N is less than Nmax (block 306). If N equals Nmax, proceed to step 5; otherwise, increment the iteration count (307) and go to step 2.
Step 5) Stop the procedure and output the groups (308).

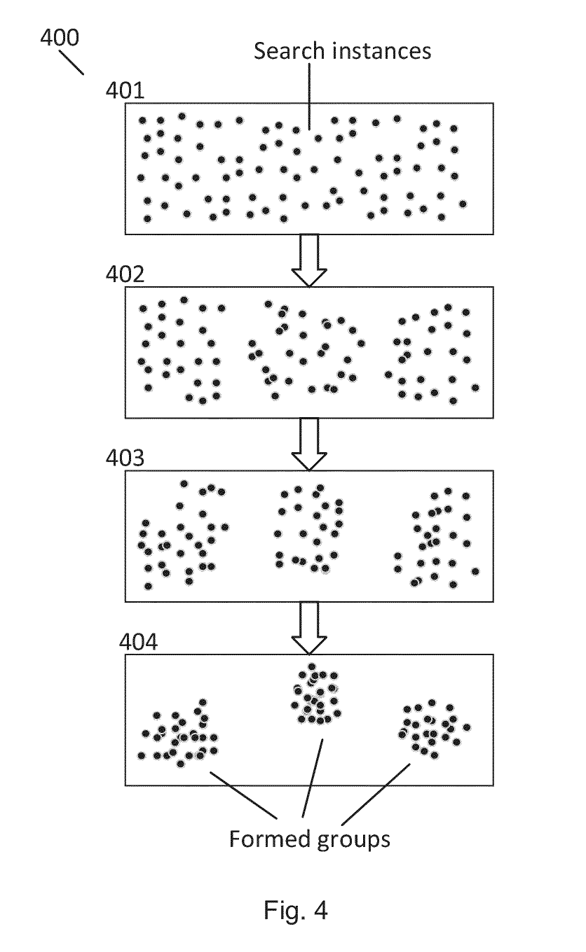

Referring to FIG. 4, the search process of stage I 400 is schematically illustrated. At the beginning of the stage, the search instances (i.e., dots in the figure) are distributed evenly in the search space and no cluster can be observed (block 401). As the stage progresses, groups start to form among search instances (block 402 and block 403). As the stopping criteria are met and the metaheuristic procedure is stopped, the search instances cluster into three stable groups (block 404).

### Stage II: Guiding

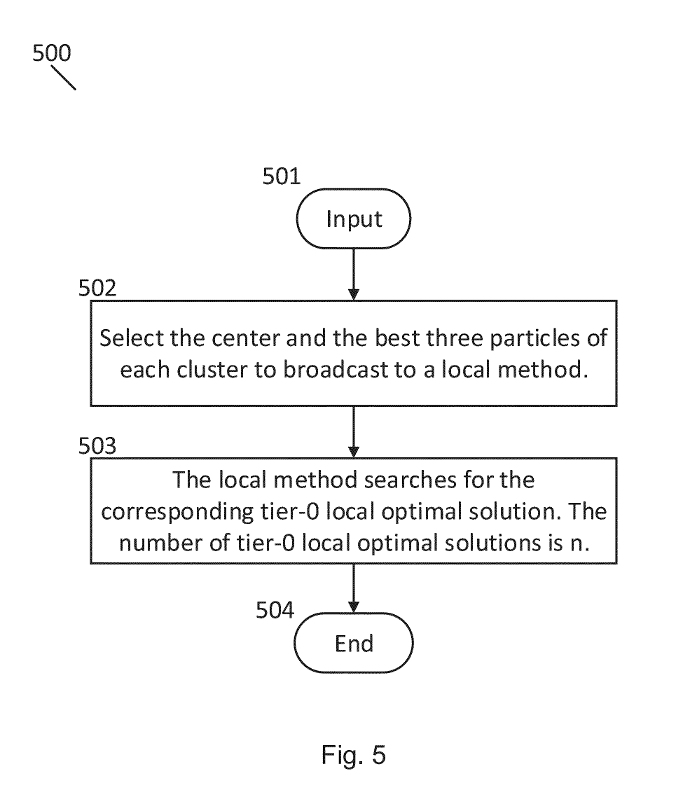

After stage I, the methodology preferably enters stage II, which is the guiding stage. This stage serves as the interface between the metaheuristic method and the TRUST-TECH method. Referring to FIG. 5, the steps of stage II 500 are preferably as follows:

1) The groups or clusters of search instances formed in stage I are the input (block 501).

2) Top few search instances and the center search instance in each group are selected as initial points for an effective local method (block 502). A search instances is determined as a top one if it results in the best objection function value. The center instance is determined as the one that is closest to the centroid of the group.

3) Starting from these initial points, the local method is applied to search for corresponding local optimal solutions (block 503). The local method can be, but not limited to, Newton's method, the quasi-Newton method, the trust-region search method, the quadratic programming method, or the interior point method.

The outputs 504 of this stage are the local optimal solutions obtained from each group. The number of local optimal solutions from each group is no more than the number of initial points.

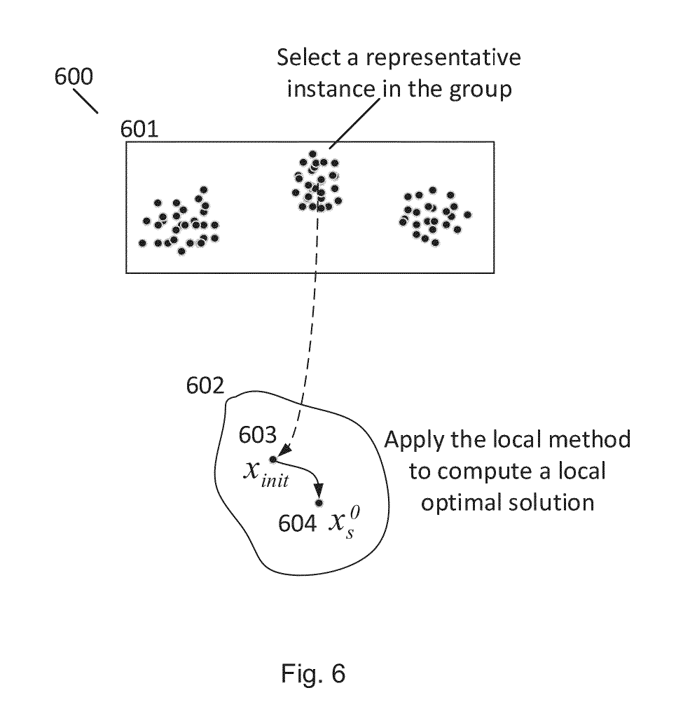

Stage II is shown schematically in FIG. 6. In this stage 600, the top three search instances and the center search instance in each of the three groups 601 are selected. Each selected instance is used as the initial point xᵢₙᵢₜ 603, and an effective local method is applied to search for a local optimal solution xₛ₀ 604 in the search region 602.

### Stage III: Exploitation

The TRUST-TECH method plays an important role in stage III, which helps the local optimal method to escape from one local optimal solution and move toward another local optimal solution. The TRUST-TECH method preferably exploits all of the local optimal solutions in each “covered” region in a tier-by-tier manner.
1) From an obtained local optimal solution of stage II, the TRUST-TECH methodology intelligently moves away from the local optimal solution and approaches, together with the local method, another local optimal solution in a tier-by-tier manner.
2) After finding the set of tier-1 local optimal solutions, the TRUST-TECH method continues to find the set of tier-2 local optimal solutions, if necessary.

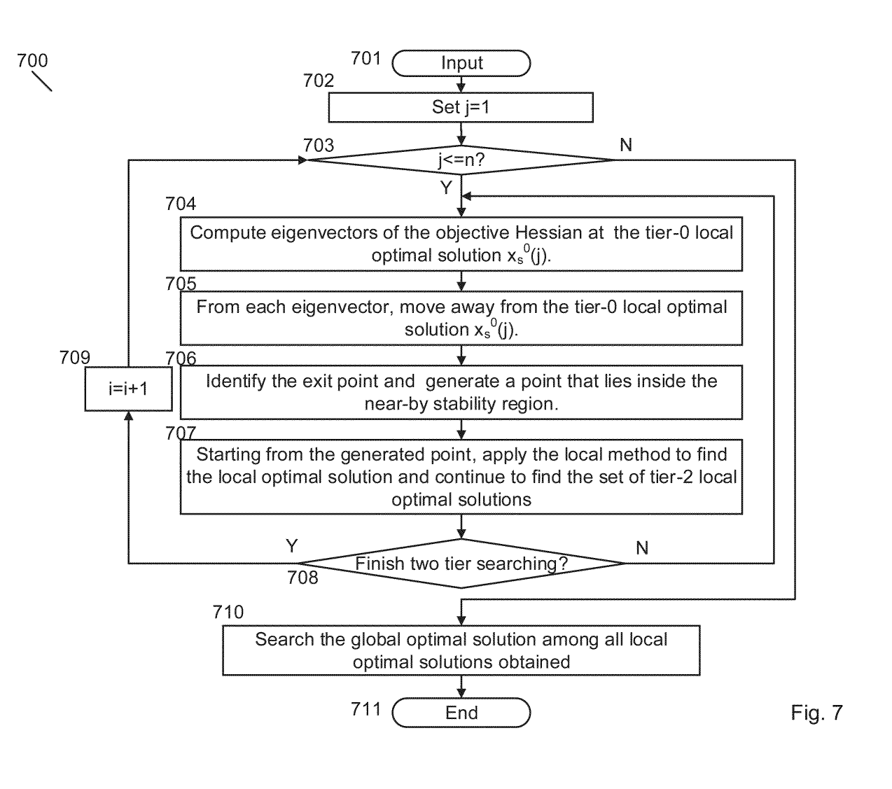

Referring to FIG. 7, a flowchart of stage III for the TRUST-TECH procedure is presented. The TRUST-TECH procedure 700 comprises the following steps. Input 701 to this stage is the set of local optimal solutions found in stage II, which are the tier-0 local optimal solutions and the number is denoted as n. The stage is initialized by setting the iteration number j=1 (block 702).
Step 1) Check if the condition j<=n is satisfied (block 703). If this condition is not satisfied, which means all tier-0 local optimal solutions have been processed, then proceed to step 7; otherwise, proceed to step 2.
Step 2) Compute eigenvectors of the objective Hessian at the set of tier-0 local optimal solutions (block 704).
Step 3) From each eigenvector, move away from the tier-0 local optimal solution xₛ₀(j) (block 705).
Step 4) Identify the exit point and from the exit point, if it exists, generate a point that is a vector lying inside the nearby stability region of the corresponding stable equilibrium point (block 706).
Step 5) Starting from the generated point at step 111-3, apply the local optimization method to find the corresponding set of tier-1 local optimal solutions xₛ₁(j) and continue to find the set of tier-2 local optimal solutions xₛ₂(j) (block 707).
Step 6) If the set of tier-1 and tier-2 local optimal solutions has been found (block 708), go to step 7. Otherwise, j=j+1 (block 709) and go back to step 1 if the condition j<=n is satisfied (block 703).
Step 7) The best local optimal solution can be identified accurately among all of the obtained local optimal solutions (block 710).

It is interesting to note that the search space of stage III is the union of the stability region for the seed local optimal solutions from stage II, the stability region of each tier-one local optimal solution from stage III, and the stability region of each tier-two local optimal solution from stage III. The exploitation procedure starts from the local optimal solutions obtained at stage II located in each group, i.e., the seed local optimal solutions. The top few local optimal solutions from all of the tier-one local optimal solutions, or some of tier-two local optimal solutions, are the outputs of this stage.

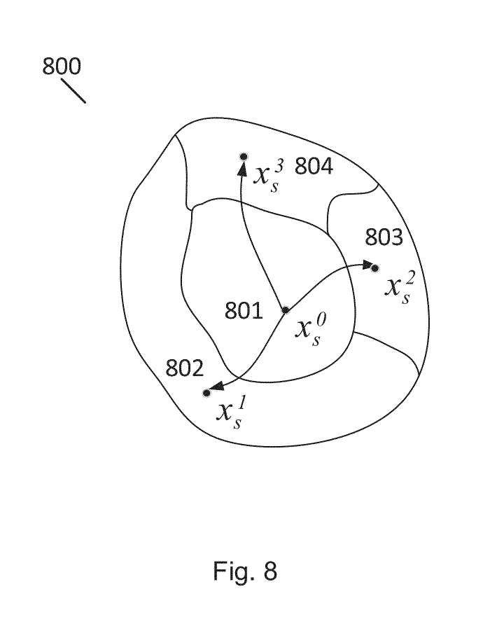

Referring to FIG. 8, the procedure of stage III for finding tier-1 local optimal solutions by the TRUST-TECH methodology is schematically illustrated (block 800). For each group, there are, at most, four local optimal solutions obtained at stage II. Starting from a local optimal solution, xₛ₀ 801, obtained in stage II, which is also a tier-0 local optimal solution, three tier-1 local optimal solutions, xₛ₁ 802, xₛ₂ 803, and xₛ₃ 804, are obtained by the TRUST-TECH methodology in stage III.

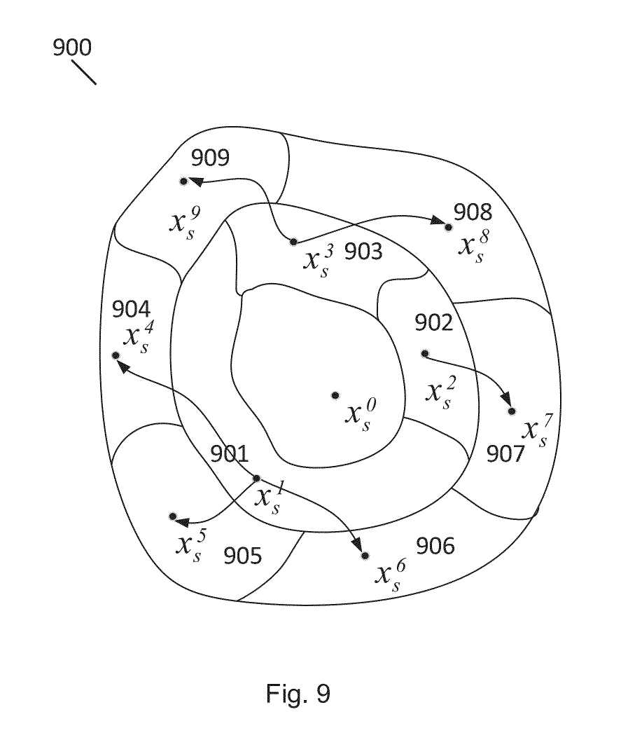

Referring to FIG. 9, the procedure of stage III for finding tier-2 local optimal solutions by the TRUST-TECH methodology is schematically illustrated (block 900). Starting from tier-1 local optimal solutions, tier-2 local optimal solutions are obtained by the TRUST-TECH methodology in stage III. More specifically, starting from the first tier-1 local optimal solution, xₛ₁ 901, three tier-2 local optimal solutions, xₛ₄ 904, xₛ₅ 905, and xₛ₆ 906, are obtained by the TRUST-TECH methodology; starting from the second tier-1 local optimal solution, xₛ₂ 902, on the tier-2 local optimal solution, xₛ₇ 907 is obtained by the TRUST-TECH methodology; and starting from the third tier-1 local optimal solution, xₛ₃ 903, two tier-2 local optimal solutions, xₛ₈ 908 and xₛ₉ 909, are obtained by the TRUST-TECH methodology.

Theoretically speaking, the TRUST-TECH methodology may continue to find the set of tier-3 local optimal solutions at the expense of considerable computational efforts. From experience, however, in the set of tier-1 local optimal solutions, there usually exists a very high-quality local optimal solution, if not the global optimal solution. Hence, the exploitation process is terminated after finding all the first-tier local optimal solutions. If necessary, the tier-2 local optimal solutions may be obtained in stage III.

The TRUST-TECH methodology may search all of the local optimal solutions in a tier-by-tier manner and then search for the high-quality optimal solution among them. If the initial point is not close to the high-quality optimal solution, then the task of finding high-quality optimal solutions may take several tiers of local optimal solution computations. Hence, an important aim of stage I is to reduce the number of tiers required to be computed at stage III. All of the search instances of the metaheuristic stage are preferably grouped into no more than a few groups of search instances when all the search instances have reached a consensus. More preferably, all of the search instances of the metaheuristic method are grouped into no more than three groups. It is likely that local optimal solutions in these regions contain the high-quality optimal solution.

There is no theoretical proof that the locations of the top few selected local optimal solutions are close to the high-quality optimal solution. However, from experience, all of the high-quality optimal solutions were obtained in all numerical studies. Selecting the top-performance search instances from each group as initial points in the guiding stage allows the scheme embedded in the stage III to be effective.

In summary, a three-stage metaheuristic-guided TRUST-TECH methodology preferably proceeds in the following manner:

### 3-Stage Metaheuristic-Guided TRUST-TECH Methodology

### Stage I: Exploration and Consensus

Use a metaheuristic method to solve the optimization problem. After a certain number of iterations, apply a grouping scheme (e.g., ISODATA) to all search instances to form the groups. In some embodiments, the number of iterations is predetermined. In other embodiments, the number of iterations is based on meeting a predetermined criterion. When the search instances in each group and the number of groups do not change with further iterations, this implies that all search instances have reached a consensus. Then, the stopping condition is met and stage I is completed.

### Stage II: Selection and Guiding Stage

Select the top few search instances in terms of their objection function value and the center particle from each group. In a preferred embodiment, the top three search instances are selected. Starting from each selected search instance, apply a local optimization method to find the corresponding local optimal solution. These local optimal solutions are then used as guidance for the TRUST-TECH methodology to search for the corresponding tier-one local optimal solutions during stage III.

### Stage III: Exploitation Stage

Starting with each obtained (tier-0) local optimal solution, apply the TRUST-TECH methodology to intelligently move away from this local optimal solution and find the corresponding set of tier-1 local optimal solutions. After finding the set of tier-1 local optimal solutions, the TRUST-TECH method continues to find the set of tier-2 local optimal solutions, if necessary. Finally, identify the best local optimal solution among tier-0, tier-1, and tier-2 local optimal solutions.

### PSO-Guided TRUST-TECH Methodology

In one embodiment, the following Particle Swarm Optimization (PSO)-guided TRUST-TECH methodology is used for solving the general unconstrained optimization problem of the form (1).

There are several variants of PSO methods to which the present methodology is applicable. As an illustration, the traditional PSO methodology is used in the following presentation. A search instance is also called a particle of the PSO method. In the initialization phase of PSO, the positions and velocities of all particles are randomly initialized. The fitness value, which is the objective function value, is calculated at each initialized position. These fitness values, respectively, are the p_{best} of each particle, which implies the optimal fitness of each particle thus far. Among these fitness values, the best one is the initial g_{best} which is the optimal fitness value among all of the particles thus far.

In each step, PSO relies on the exchange of information between particles of the swarm. This process includes updating the velocity of a particle and then its position. The former is accomplished by the following equation:

vᵢ^{k+1}=wvᵢ^{k}+c₁r₁(p_{ibest}−xᵢ^{k})+c₂r₂(g_{best}−xᵢ^{k}), (3)

where vᵢ^{k} is the velocity of the ith particle at the k-th step, xᵢ^{k} denotes the position of the i-th particle at the k-th step, w is the inertia weight that is used to seek a balance between the exploitation and exploration ability of particles, c₁ and c₂ are constants that say how much the particle is directed towards good positions and both are typically set to a value of 2.0, and r₁ and r₂ are elements drawn from two uniform random sequences in the range (0,1).

The velocity updating equation (3) indicates that the PSO search procedure preferably consists of three parts. The first part represents the inertia of a particle itself. The second represents the next search direction in which each particle should move: its own previous best position. The third part indicates that each particle should move towards the best position of all particles thus far.

The new position of each particle is calculated using:

xᵢ^{k+1}=xᵢ^{k}+vᵢ^{k+1}. (4)

To achieve an update for each particle's velocity, the new fitness value is preferably calculated at the new position to replace the previous p_{best} or g_{best} if a better fitness value is obtained. This procedure is repeated until the stopping criterion is met.

There are also several improved variants of the PSO method, such as designing a new mathematical model of PSO by using other methods or combining with different mutation strategies to enhance their search performance. Despite these improvements, PSO-based methods still suffer from several disadvantages. First, these methods usually do not converge to the global optimal solution and can easily be entrapped in a local optimal solution, which affects the convergence precision or even results in divergence and calculation failure. Additionally, their computational speed can be very slow. Furthermore, they lack the scalability to find the global optimal solution of large-scale optimization problems as compared to small-scale problems with a similar topological structure.

According to the characteristics of the TRUST-TECH method and the PSO method mentioned above, the present method is developed as a PSO-guided TRUST-TECH method for solving general nonlinear optimization problems of the form (1). Referring to FIG. 2, this methodology 200 preferably includes three main stages, described herein as stage I for exploration and consensus 201 by solving the optimization problem (1) using the metaheuristic method, which is herein the PSO method, and determining whether the PSO method continues to run based on the stopping criterion; stage II for selecting the best points and the center point in each consensus group as initial points for a local method and searching for local optimal solutions 202; and stage III for exploiting the search space by starting from the results of stage II and finding tier-1 and tier-2 local optimal solutions using TRUST-TECH, and identifying the best local optimal solution 203.

### Stage I: Exploration and Consensus

Referring to FIG. 3, a flowchart summarizes stage I for exploration and consensus. Stage I 300 of the method of the present invention comprises the following steps.
Step 1) The PSO method is initialized by setting the maximum number of iterations, denoted as Nmax; the number of iterations, denoted as K, for consensus checking; and setting the iteration counter N=1 (block 301).
Step 2) Solve the optimization problem (1) using the PSO method. More specifically, a single PSO update is carried out (block 302).
Step 3) The iteration counter N is checked (block 303). If N is a multiplier of the consensus checking interval, K, then the particles are clustered (304) and proceed to step 4; otherwise, proceed to step 4 directly.
Step 4) Check if the stopping criteria are met (block 305). The stopping criteria include: 1) the number of groups of particles is not changed, and 2) the members in each group are not changed. If the stopping criteria are met, then proceed to step 5; otherwise, check if the PSO iteration counter N is less than Nmax (block 306). If N equals Nmax, proceed to step 5; otherwise, increment the iteration count (307) and go to step 2.
Step 5) Stop the procedure and output the groups (308).

Referring to FIG. 4, the search process of stage I 400 is schematically illustrated. At the beginning of the stage, the particles are distributed evenly in the search space and no cluster can be observed (block 401). As the stage progresses, groups start to form among particles (block 402 and block 403). As the stopping criteria are met and the PSO procedure is stopped, the particles cluster into three stable groups (block 404).

### Stage II: Guiding

After stage I, the methodology preferably enters stage II, which is the guiding stage. This stage serves as the interface between the PSO method and the TRUST-TECH method. Referring to FIG. 5, the steps of stage II 500 are preferably as follows:
1) The groups formed in stage I are the input (block 501).
2) Top few particles and the center particle in each group are selected as initial points for a local method (block 502). A particle is determined as a top one if it results in the best objection function value. The center particle is determined as the one that is closest to the centroid of the group.
3) Starting from these points, an effective local method is applied to search for corresponding local optimal solutions (block 503).

The outputs 504 of this stage are the local optimal solutions obtained from each group. The number of local optimal solutions from each group is no more than the number of initial points.

Stage II is shown schematically in FIG. 6. In this stage 600, the top three particles and the center point in each of the three groups 601 are selected. Each selected point is used as the initial point xinit 603, and an effective local method is applied to search for a local optimal solution xs0 604 in the search region 602.

### Stage III: Exploitation Stage

The TRUST-TECH method plays an important role in stage III, which helps the local optimal method to escape from one local optimal solution and move toward another local optimal solution. The TRUST-TECH method preferably exploits all of the local optimal solutions in each “covered” region in a tier-by-tier manner.
1) From an obtained local optimal solution of stage II, the TRUST-TECH methodology intelligently moves away from the local optimal solution and approaches, together with the local method, another local optimal solution in a tier-by-tier manner.
2) After finding the set of tier-1 local optimal solutions, the TRUST-TECH method continues to find the set of tier-2 local optimal solutions, if necessary.

In summary, a three-stage PSO-guided TRUST-TECH methodology preferably proceeds in the following manner:

### Stage I: Exploration and Consensus

Use a PSO or an improved PSO method to solve the optimization problem. After a certain number of iterations, apply a grouping scheme (e.g., ISODATA) to all the particles to form the groups. In some embodiments, the number of iterations is predetermined. In other embodiments, the number of iterations is based on meeting a predetermined criterion. When the members in each group and the number of groups do not change with further iterations, this implies that all the particles have reached a consensus. Then, the stopping condition is met and stage I is completed.

### Stage II: Selection and Guiding

Select the top few particles in terms of their objection function value and the center particle from each group. In a preferred embodiment, the top three particles are selected. Starting from each selected particle, apply a local optimization method to find the corresponding local optimal solution. These local optimal solutions are then used as guidance for the TRUST-TECH methodology to search for the corresponding tier-one local optimal solutions during stage III.

### Stage III: Exploitation

Starting with each obtained (tier-0) local optimal solution, apply the TRUST-TECH methodology to intelligently move away from this local optimal solution and find the corresponding set of tier-1 local optimal solutions. After finding the set of tier-1 local optimal solutions, the TRUST-TECH method continues to find the set of tier-2 local optimal solutions, if necessary. Finally, identify the best local optimal solution among tier-0, tier-1, and tier-2 local optimal solutions.

### GA-Guided TRUST-TECH Methodology

In an alternative embodiment, the following Genetic Algorithm (GA)-guided TRUST-TECH methodology is used for solving general unconstrained optimization problems.

The genetic algorithm preferably contains the following steps.
1) The algorithm begins by creating a random initial population, each individual in which corresponds to a search instance.
2) The algorithm then creates a sequence of new populations. At each step, the algorithm uses the individuals in the current generation to create the next population. To create the new population, the algorithm preferably performs the following steps:
   2.1) Scores each individual of the current population by computing its fitness value, which is the objective function value.
   2.2) Scales the raw fitness scores to convert them into a more usable range of values.
   2.3) Selects individuals, called parents, based on their fitness.
   2.4) Chooses some individuals in the current population that have lower fitness as elite ones and passes to the next population.
   2.5) Produces children from the parents. Children are produced either by making random changes to a single parent, called mutation, or by combining the vector entries of a pair of parents, called crossover.
   2.6) Replaces the current population with the children to form the next generation.
3) The algorithm stops when one of the stopping criteria is met. Stopping criteria for the GA procedure can include:
   3.1) The maximum number of generations is reached.
   3.2) The maximum allowed amount of CPU time is reached.
   3.3) The best fitness value of the current population is less than or equals to a predefined value.

According to the characteristics of the TRUST-TECH method and the GA method mentioned above, the present method is developed as a GA-guided TRUST-TECH method for solving general nonlinear optimization problems of the form (1). Referring to FIG. 2, this methodology 200 preferably includes three main stages, described herein as stage I for exploration and consensus 201 by solving the optimization problem (1) using the metaheuristic method, which is herein the GA method, and determining whether the GA method continues to run based on the stopping criterion; stage II for selecting the best points and the center point in each consensus group as initial points for a local method and searching for local optimal solutions 202; and stage III for exploiting the search space by starting from the results of stage II and finding tier-1 and tier-2 local optimal solutions using TRUST-TECH, and identifying the best local optimal solution 203.

### Stage I: Exploration and Consensus

Referring to FIG. 3, a flowchart summarizes stage I for exploration and consensus. Stage I 300 of the method of the present invention comprises the following steps.
Step 1) The GA method is initialized by setting the maximum number of iterations, denoted as Nmax; the number of iterations, denoted as K, for consensus checking; and setting the iteration counter N=1 (block 301).
Step 2) Solve the optimization problem (1) using the GA method. More specifically, a single GA evolution is carried out (block 302).
Step 3) The iteration counter N is checked (block 303). If N is a multiplier of the consensus checking interval, K, then the individuals are clustered (304) and proceed to step 4; otherwise, proceed to step 4 directly.
Step 4) Check if the stopping criteria are met (block 305). The stopping criteria include: 1) the number of groups of individuals is not changed, and 2) the individuals in each group are not changed. If the stopping criteria are met, then proceed to step 5; otherwise, check if the PSO iteration counter N is less than Nmax (block 306). If N equals Nmax, proceed to step 5; otherwise, increment the iteration count (307) and go to step 2.
Step 5) Stop the procedure and output the groups (308).

Referring to FIG. 4, the search process of stage I 400 is schematically illustrated. At the beginning of the stage, the individuals are distributed evenly in the search space and no cluster can be observed (block 401). As the stage progresses, groups start to form among the individuals (block 402 and block 403). As the stopping criteria are met and the PSO procedure is stopped, the individuals cluster into three stable groups (block 404).

### Stage II: Guiding

After stage I, the methodology preferably enters stage II, which is the guiding stage. This stage serves as the interface between the GA method and the TRUST-TECH method. Referring to FIG. 5, the steps of stage II 500 are preferably as follows:
1) The groups formed in stage I are the input (block 501).
2) Top few individuals and the center individual in each group are selected as initial points for a local method (block 502). An individual is determined as a top one if it results in the best objection function value. The center individual is determined as the one that is closest to the centroid of the group.
3) Starting from these points, an effective local method is applied to search for corresponding local optimal solutions (block 503).

The outputs 504 of this stage are the local optimal solutions obtained from each group. The number of local optimal solutions from each group is no more than the number of initial points.

Stage II is shown schematically in FIG. 6. In this stage 600, the top three individuals and the center individual in each of the three groups 601 are selected. Each selected individual is used as the initial point xinit 603, and an effective local method is applied to search for a local optimal solution xs0 604 in the search region 602.

### Stage III: Exploitation

The TRUST-TECH method plays an important role in stage III, which helps the local optimal method to escape from one local optimal solution and move toward another local optimal solution. The TRUST-TECH method preferably exploits all of the local optimal solutions in each “covered” region in a tier-by-tier manner.
1) From an obtained local optimal solution of stage II, the TRUST-TECH methodology intelligently moves away from the local optimal solution and approaches, together with the local method, another local optimal solution in a tier-by-tier manner.
2) After finding the set of tier-1 local optimal solutions, the TRUST-TECH method continues to find the set of tier-2 local optimal solutions, if necessary.

In summary, a three-stage GA-guided TRUST-TECH methodology preferably proceeds in the following manner:

### Stage I: Exploration and Consensus

Use a GA or an improved GA method to solve the optimization problem. After a certain number of iterations, apply a grouping scheme (e.g., ISODATA) to all the individuals to form the groups. In some embodiments, the number of iterations is predetermined. In other embodiments, the number of iterations is based on meeting a predetermined criterion. When the individuals in each group and the number of groups do not change with further iterations, this implies that all the particles have reached a consensus. Then, the stopping condition is met and stage I is completed.

### Stage II: Selection and Guiding

Select the top few individuals in terms of their objection function value and the center particle from each group. In a preferred embodiment, the top three individuals are selected. Starting from each selected individuals, apply a local optimization method to find the corresponding local optimal solution. These local optimal solutions are then used as guidance for the TRUST-TECH methodology to search for the corresponding tier-one local optimal solutions during stage III.

### Stage III: Exploitation

Starting with each obtained (tier-0) local optimal solution, apply the TRUST-TECH methodology to intelligently move away from this local optimal solution and find the corresponding set of tier-1 local optimal solutions. After finding the set of tier-1 local optimal solutions, the TRUST-TECH method continues to find the set of tier-2 local optimal solutions, if necessary. Finally, identify the best local optimal solution among tier-0, tier-1, and tier-2 local optimal solutions.

### Numerical Results on Benchmark Functions

The methods of the present invention are first evaluated on five 1000-dimensional benchmark functions. These benchmark functions include

$$\begin{matrix}F ( x ) = {\sum }_{i = 1}^{1000} ( exp ( {x}_{i} ) - {ix}_{i} ) , - 500 \leq {x}_{i} \leq 500 , i = 1 , … , 1000. & ( 5 ) \\ F ( x ) = {\sum }_{i = 1}^{1000} ( exp ( {x}_{i} ) - \frac{{x}_{i}}{i} ) , - 500 \leq {x}_{i} \leq 500 , i = 1 , … , 1000. & ( 6 ) \\ F ( x ) = {\sum }_{i = 1}^{1000} ( exp ( {x}_{i} ) - i sin ( {x}_{i} ) ) , \\ - 500 \leq {x}_{i} \leq 500 , i = 1 , … , 1000. & ( 7 ) \\ F ( x ) = {\sum }_{i = 1}^{1000} ( exp ( {x}_{i} ) - \sqrt{i} {x}_{i} ) , \\ - 500 \leq {x}_{i} \leq 500 , i = 1 , … , 1000. & ( 8 ) \\ F ( x ) = {\sum }_{i = 1}^{1000} ( \frac{i}{10} exp ( {x}_{i} ) - {x}_{i} ) , \\ - 500 \leq {x}_{i} \leq 500 , i = 1 , … , 1000. & ( 9 )\end{matrix}$$

The advantages of using this methodology are clearly manifested, as illustrated by the results in the following five cases. Stage I uses a traditional PSO method. The number of particles of PSO is set to be 30, and the maximum iteration number is set to be 1000.

Stage I provides the covered search region and the locations of optimal solutions after the particles have reached a consensus, while Stage II provides the corresponding tier-0 local optimal solutions from the three best particles and the center point of each region. Stage III searches for the tier-1 or tier-2 local optimal solutions, starting from these tier-0 local optimal solutions, and obtains a set of high-quality optimal solutions, preferably including the global optimal solution.

Numerical results on these benchmark functions show that, at stage I, the behavior of the best particle objective function value does not sharply decline after a certain number of iterations. This means that all particles have reached a consensus at which the number of groups of particles and the members in each group do not change upon further iterations. At stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group. At stage III, the TRUST-TECH method led the local method to exploit all the local optimal solutions lying within each region in a tier-by-tier manner. The best top local optimal solutions were then identified. It is observed that the average degree of improvement of stage III over the stage II result in each group ranges from 11% to 71%.

To further compare the performance of the present methodology to a PSO method, the five testing functions were solved by the PSO method for a total of 20,000 iterations. It can be easily noted that the present methodology outperforms the PSO with 20,000 iterations for solving general high dimensional optimization problems. The PSO-guided TRUST-TECH method of the present invention obtains better local optimal solutions than the PSO with much shorter computation time. In summary, the present PSO-guided TRUST-TECH method of the present invention can significantly improve the performance of PSO in solving large-scale optimization problems.

### Application to Short-Term Load Forecasting in Power Systems

The method of the present invention is then applied to a practical application, namely, short-term load forecasting (STLF) in power systems.

Load forecasting is a key component of the daily operation and planning of an electric utility, such as generation scheduling, scheduling of fuel purchase, maintenance scheduling, and security analysis. Short-term load forecasting, which aims to produce forecasts for a few minutes, hours, or days ahead, in particular, has become increasingly important since the rise of a competitive energy market and the increasing penetration of renewable energies. Despite its importance, accurate load forecasting is a difficult task. First, the load series is complex and exhibits several levels of seasonality. Second, there are many important factors, especially weather-related ones, that must be considered in the forecasts. The relationship between these factors and the load forecast has been found to be highly nonlinear. Researchers showed that it is relatively easy to construct a forecaster whose performance is about 10% in terms of the mean absolute percent error (MAPE); however, the error costs are too high to be acceptable. A much tighter operations load forecast performance is required for practical usage by electric utilities.

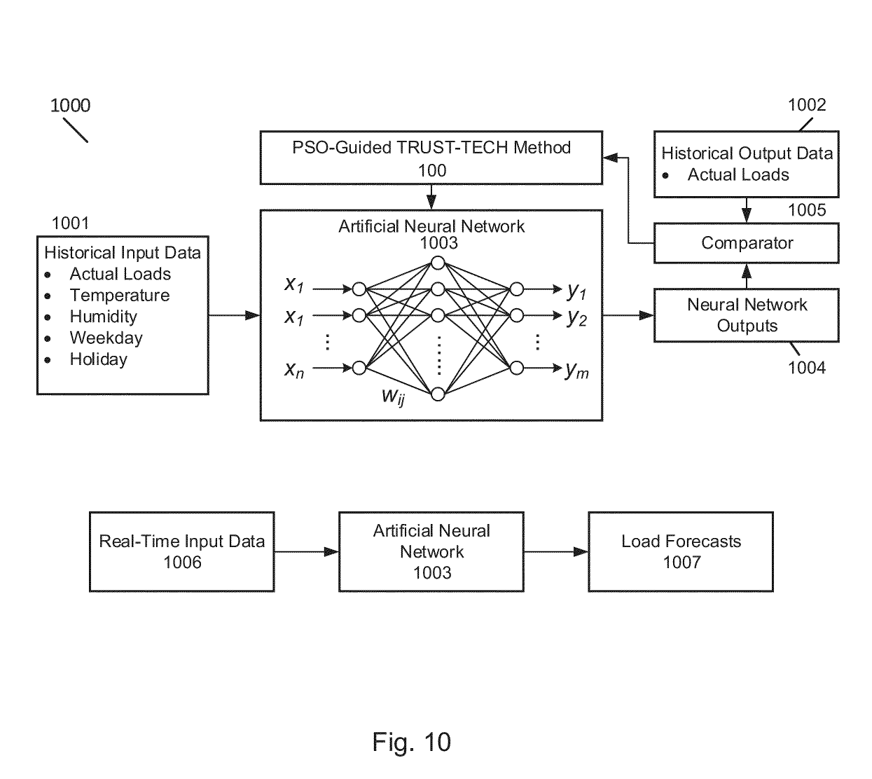

Referring to FIG. 10, the application of the present method to load forecasting 1000 comprises two stages, i.e., the training stage and the application stage. During training the ANN 1003 for load forecasting, a historical dataset is prepared, which includes the historical input data 1001 and the historical output data 1002. In one embodiment of the present method, a input data vector is of 147 dimensions, which consists of the historical load values, the historical and forecasted temperature and humidity values, the weekday number, and the holiday index. The output vector is of 24 dimensions, corresponding to the 24-hour load forecasts on the forecasted day. The number of ANN input nodes is 147, the number of ANN output nodes is 24, and the number of ANN hidden layer nodes is 25. Therefore, there are 4234 weights in the ANN. In other embodiments of the present method, the organization of the input and output data can be different.

During training the ANN 1003, the comparator 1005 compares the ANN outputs 1004 with the historical (actual) outputs 1002. In one embodiment of the present method, during training the ANN for load forecasting, the optimization problem (1) can be expressed as finding the best weights to minimize the mean squared error (MSE) between the ANN outputs and the actual loads, which is defined as

$${min}_{w} C ( w ) = \frac{1}{N} {\sum }_{i = 1}^{N} {‖ F ( {X}_{i} ; w ) - {Y}_{i} ‖}^{2} , \qquad ( 10 )$$

where Xᵢ=(x₁, x₂, . . . , xₙ) is the i-th historical input data vector, Yᵢ=(y₁, y₂, . . . , yₘ) is the i-th historical output data vector, the parameter values w is the vector of weights connecting the nodes of the ANN, N is the number of samples in the historical dataset, and F(Xᵢ;w) is the output of the ANN given the i-th input vector Xᵢ and is the forecast for K. The objective function C(w) of training an ANN is usually a nonlinear and nonconvex function of the parameter values w and can have many local optimal solutions. Considering that there are 4324 weights in the ANN, the optimization problem (10) of training the ANN for load forecasting is therefore a 4324-dimensional optimization problem.

To solve the optimization problem (10) to find the global optimal solution, that is, the global optimal parameters for the ANN 1003, the present PSO-guided TRUST-TECH method 100 of this invention is applied. Referring to FIG. 2, the optimization problem (10) for training an ANN for load forecasting is preferably solved in three main stages, described herein as stage I for exploration and consensus 201 by solving the optimization problem (10) using the metaheuristic method, which is herein the PSO method, and determining whether the PSO method continues to run based on the stopping criterion; stage II for selecting the best points and the center point in each consensus group as initial points for a local method, which is herein a backpropagation method, and searching for local optimal solutions 202; and stage III for exploiting the search space by starting from the results of stage II and finding tier-1 and tier-2 local optimal solutions using TRUST-TECH, and identifying the best local optimal solution 203 that corresponds to the global optimal solution.

### Stage I: Exploration and Consensus

Referring to FIG. 3, a flowchart summarizes stage I for exploration and consensus. Stage I 300 of the method of the present invention comprises the following steps.
Step 1) The PSO method is initialized by setting the maximum number of iterations, denoted as Nmax; the number of iterations, denoted as K, for consensus checking; and setting the iteration counter N=1 (block 301). Each particle of the PSO method is herein a vector of ANN parameters and is a realization of the ANN.
Step 2) Solve the optimization problem (10) using the PSO method. More specifically, a single PSO update is carried out (block 302).
Step 3) The iteration counter N is checked (block 303). If N is a multiplier of the consensus checking interval, K, then the particles are clustered (304) and proceed to step 4; otherwise, proceed to step 4 directly.
Step 4) Check if the stopping criteria are met (block 305). The stopping criteria include: 1) the number of groups of particles is not changed, and 2) the members in each group are not changed. If the stopping criteria are met, then proceed to step 5; otherwise, check if the PSO iteration counter N is less than Nmax (block 306). If N equals Nmax, proceed to step 5; otherwise, increment the iteration count (307) and go to step 2.
Step 5) Stop the procedure and output the groups (308).

### Stage II: Guiding

After stage I, the method preferably enters stage II, which is the guiding stage. Referring to FIG. 5, the steps of stage II 500 are preferably as follows:
1) The groups formed in stage I are the input (block 501).
2) Top few particles and the center particle in each group are selected as initial points for a local method (block 502). A particle is determined as a top one if it results in the smallest MSE value. The center particle is determined as the one that is closest to the centroid of the group.
3) Starting from these points, an effective local method, which is herein a backpropagation method, is applied to search for corresponding local optimal solutions (block 503).

The outputs 504 of this stage are the local optimal solutions obtained from each group. Each local optimal solution corresponds to a local optimal set of weights of the ANN. The number of local optimal solutions from each group is no more than the number of initial points.

### Stage III: Exploitation Stage

In this stage, the TRUST-TECH method preferably exploits all of the local optimal solutions in each “covered” region in a tier-by-tier manner
1) From an obtained local optimal solution of stage II, the TRUST-TECH methodology intelligently moves away from the local optimal solution and approaches, together with the local method, another local optimal solution in a tier-by-tier manner.
2) After finding the set of tier-1 local optimal solutions, the TRUST-TECH method continues to find the set of tier-2 local optimal solutions, if necessary.
3) Finally, identify the best local optimal solution among tier-0, tier-1, and tier-2 local optimal solutions.

After applying the present PSO-guided TRUST-TECH method, the global optimal solution, which is the global optimal parameters for the ANN, is obtained. The ANN realized with the global optimal parameters is termed a trained ANN.

Once the ANN has been trained, it can be used in real-time environment to produce load forecasts for a future time, for example the next day, using currently available data. More specifically, real-time input data 1006 is organized as an input vector with the same component and order as that in the training stage and fed to the trained ANN 1003. The ANN then outputs the 24 hourly load forecasts 1007 for next day. This process can be carried out repeatly, for instance, once a day.

The present load forecaster is applied to a utility-provided dataset. The dataset covers a four-year time period, from Mar. 1, 2003 to Dec. 31, 2006. The data for the first three years is used for training, and the data for the remaining one year is used for testing. Performance of ANNs trained with the method of the present invention is compared with that of several other methods, including the naïve ANN, the similar day-based wavelet neural network (SIWNN), the strategic seasonality-adjusted support vector regression model (SSA-SVR), and the Gaussian process (GP) method. The results show that the forecaster built with the method of the present invention produces the closest match between forecasts and the actual loads.

Numerically, the forecasting performance is represented by the mean absolute percent error (MAPE), which is evaluated as follows:

$$MAPE = \frac{1}{N} {\sum }_{i = 1}^{N} \frac{1}{24} {\sum }_{j = 1}^{24} \frac{\vert {\hat{L}}_{i}^{j} - {L}_{i}^{j} \vert}{{L}_{i}^{j}} , \qquad ( 11 )$$

where N is the number of total days in the dataset, Lᵢ^{j} and \hat{L}ᵢ^{j} are the actual and forecasted loads at the j-th hour on the i-th day, respectively. The results show that the MAPE by the forecaster built with the method of the present invention is 1.28%. In contrast, the MAPE by the naïve ANN is 2.03%, the MAPE by SIWNN is 1.71%, the MAPE by GP is 1.37%, and the MAPE by SSA-SVR is 1.31%. In other words, the method of the present invention is able to improve the forecasting performance produced by the naïve ANN by a significant rate of 36.95%, SIWNN by a rate of 25.15%, GP by a rate of 6.57%, and by SSA-SVR by a rate of 2.29%.

Embodiments of the techniques disclosed herein may be implemented in hardware, software, firmware, or a combination of such implementation approaches. In one embodiment, the methods described herein may be performed by a processing system. A processing system includes any system that has a processor, such as, for example; a digital signal processor (DSP), a microcontroller, an application specific integrated circuit (ASIC), or a microprocessor. One example of a processing system is a computer system.

Referring back to FIG. 10, the computer system 1000 may be a server computer, or any machine capable of executing a set of instructions (sequential or otherwise) that specify actions to be taken by that machine. While only a single machine is illustrated, the term “machine” shall also be taken to include any collection of machines (e.g., computers) that individually or jointly execute a set (or multiple sets) of instructions to perform any one or more of the methodologies discussed herein.

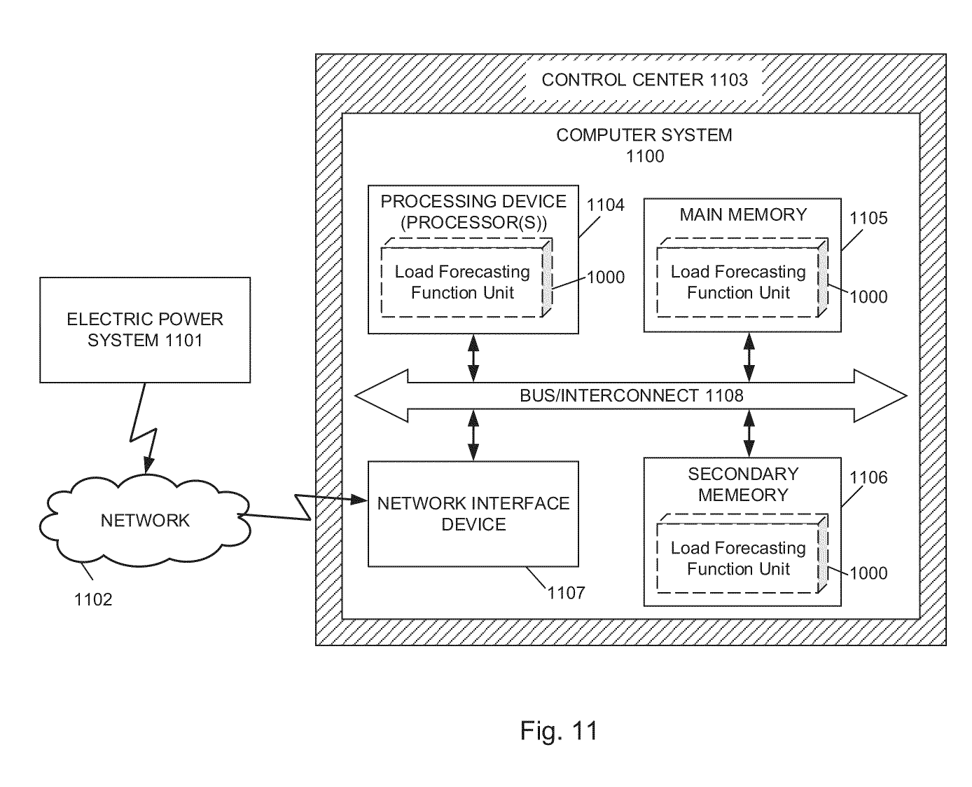

FIG. 11 shows a block diagram of an environment for running the application of FIG. 10. Computer system 1100 includes a processing device 1104. The processing device 1104 represents one or more general-purpose processors, or one or more special-purpose processors, or any combination of general-purpose and special-purpose processors. In one embodiment, the processing device 1104 is adapted to execute the operations of the load forecasting function unit 1000 of FIG. 10, which performs the methods and/or processes described in connection with FIG. 10 for performing load forecasting.

In one embodiment, the processor device 1104 is coupled, via one or more buses or interconnects 1108, to one or more memory devices such as: a main memory 1105 (e.g., read-only memory (ROM), flash memory, dynamic random access memory (DRAM), a secondary memory 1106 (e.g., a magnetic data storage device, an optical magnetic data storage device, etc.), and other forms of computer-readable media, which communicate with each other via a bus or interconnect. The memory devices may also different forms of read-only memories (ROMs), different forms of random access memories (RAMs), static random access memory (SRAM), or any type of media suitable for storing electronic instructions. In one embodiment, the memory devices may store the code and data of the load forecasting function unit 1000. In the embodiment of FIG. 11, the load forecasting function unit 1000 may be located in one or more of the locations shown as dotted boxes and labeled by the reference numeral 1000.

The computer system 1100 may further include a network interface device 1107. A part or all of the data and code of the load forecasting function unit 1000 may be transmitted or received over a network 1102 via the network interface device 1107. Although not shown in FIG. 11, the computer system 1100 also may include user input/output devices (e.g., a keyboard, a touchscreen, speakers, and/or a display).

In one embodiment, the load forecasting function unit 1100 can be implemented using code and data stored and executed on one or more computer systems (e.g., the computer system 1100). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices as shown in FIGS. 11 as 1105 and 1106) and transitory computer-readable transmission media (e.g., electrical, optical, acoustical or other form of propagated signals—such as carrier waves, infrared signals). A non-transitory computer-readable medium of a given computer system typically stores instructions for execution on one or more processors of that computer system. One or more parts of an embodiment of the invention may be implemented using different combinations of software, firmware, and/or hardware.

The operations of the methods and/or processes of FIG. 1-10 have been described with reference to the exemplary embodiment of FIG. 11. However, it should be understood that the operations of the methods and/or processes of FIG. 1-10 can be performed by embodiments of the invention other than those discussed with reference to FIG. 11, and the embodiment discussed with reference to FIG. 11 can perform operations different from those discussed with reference to the methods and/or processes of FIG. 1-10. While the methods and/or processes of FIG. 1-10 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of determining a global optimal solution of a system defined by a plurality of nonlinear equations, the method comprising the steps of:
a) a computer applying a metaheuristic method to cluster a plurality of search instances into at least one promising region that may contain the global optimal solution;
b) the computer selecting a center point and a plurality of top points from the search instances in each promising region;
c) the computer applying a local method starting from the center point and top points for each promising region to find a local optimal solution for each promising region in a tier-by-tier manner;
d) the computer applying a TRUST-TECH methodology to each local optimal solution to find a set of tier-1 optimal solutions; and
e) the computer determining a best solution among the local optimal solutions and the tier-1 optimal solutions and identifying the best solution as the global optimal solution.

2. The method of claim 1 further comprising the steps of:
f) the computer applying the TRUST-TECH methodology to each tier-1 optimal solution to find a set of tier-2 optimal solutions; and
g) the computer re-determining the best solution among the local optimal solutions, the tier-1 optimal solutions, and the tier-2 optimal solutions and re-identifying the best solution as the global optimal solution.

3. The method of claim 2 further comprising the steps of:
h) the computer applying the TRUST-TECH methodology to each tier-2 optimal solution to find a set of tier-3 optimal solutions; and
i) the computer re-determining the best solution among the local optimal solutions, the tier-1 optimal solutions, the tier-2 optimal solutions, and the tier-3 optimal solutions and re-identifying the best solution as the global optimal solution.

4. The method of claim 1, wherein the plurality of top points consists of a first top point, a second top point, and a third top point.

5. The method of claim 1, wherein the at least one promising region consists of no more than three groups.

6. The method of claim 1, wherein step a) comprises the substep of the computer iteratively applying the metaheuristic method until the number of promising regions is unchanged and no search instances are moving between promising regions in successive iterations.

7. The method of claim 1, wherein step a) comprises the substep of the computer applying a grouping scheme to the search instances to determine the at least one promising region.

8. The method of claim 1, wherein in step b), the top points are selected based on the objective function values of the points.

9. The method of claim 1 further comprising the step of the computer generating the plurality of search instances, each search instance having a randomly generated position, prior to step a).

10. The method of claim 1, wherein the metaheuristic method is a particle swarm optimization method.

11. The method of claim 1, wherein the metaheuristic method is an improved particle swarm optimization method.

12. The method of claim 1, wherein the metaheuristic method is a genetic algorithm.

13. A computer program product for determining a global optimal solution of a system defined by a plurality of nonlinear equations, the computer program product comprising:
at least one computer-readable, non-transitory tangible storage device;
program instructions, stored on the at least one computer-readable, non-transitory tangible storage device, to apply a metaheuristic method to cluster a plurality of search instances into at least one promising region that may contain the global optimal solution;
program instructions, stored on the at least one computer-readable, non-transitory tangible storage device, to select a center point and a plurality of top points from the search instances in each promising region;
program instructions, stored on the at least one computer-readable, non-transitory tangible storage device, to apply a local method starting from the center point and top points for each promising region to find a local optimal solution for each promising region in a tier-by-tier manner;
program instructions, stored on the at least one computer-readable, non-transitory tangible storage device, to apply a TRUST-TECH methodology to each local optimal solution to find a set of tier-1 optimal solutions; and
program instructions, stored on the at least one computer-readable, non-transitory tangible storage device, to determine a best solution among the local optimal solutions and the tier-1 optimal solutions and to identify the best solution as the global optimal solution.

14. The computer program product of claim 13 further comprising:
program instructions, stored on the at least one computer-readable, non-transitory tangible storage device, to apply the TRUST-TECH methodology to each tier-1 optimal solution to find a set of tier-2 optimal solutions; and
program instructions, stored on the at least one computer-readable, non-transitory tangible storage device, to re-determine the best solution among the local optimal solutions, the tier-1 optimal solutions, and the tier-2 optimal solutions and to re-identify the best solution as the global optimal solution.

15. The computer program product of claim 14 further comprising:
program instructions, stored on the at least one computer-readable, non-transitory tangible storage device, to apply the TRUST-TECH methodology to each tier-2 optimal solution to find a set of tier-3 optimal solutions; and
program instructions, stored on the at least one computer-readable, non-transitory tangible storage device, to re-determine the best solution among the local optimal solutions, the tier-1 optimal solutions, the tier-2 optimal solutions, and the tier-3 optimal solutions and re-identify the best solution as the global optimal solution.

16. The computer program product of claim 13, wherein the top points are selected based on the objective function values of the points.

17. The computer program product of claim 13 further comprising program instructions, stored on the at least one computer-readable, non-transitory tangible storage device, to generate the plurality of search instances, each search instance having a randomly generated position.

18. The computer program product of claim 13, wherein the metaheuristic method is a particle swarm optimization method.

19. The computer program product of claim 13, wherein the metaheuristic method is a genetic algorithm method.

20. A method of modeling and optimizing performance in complex systems by solving nonlinear optimization problems representing the complex system, comprising the steps of:
a) exploration and consensus by metaheuristic methods comprising:
i) solving an optimization problem using a metaheuristic method;
ii) organizing search instances as clusters of search instances;
iii) repeating the metaheuristic method from step (a)(i) until a stopping criterion is met;
b) guiding local methods with representative points, comprising:
i) selecting a center and best search instances from each cluster of search instances;
ii) starting from the center and the best search instances, using a local method to search for a tier-0 local optimal solution for each cluster of search instances; and
c) starting with the local optimal solutions for the clusters of search instances, exploiting the search space using a TRUST-TECH methodology, comprising:
i) computing eigenvectors of the objective Hessian for each of the tier-0 local optimal solutions;
ii) for each of the eigenvectors, move away from the tier-0 local optimal solution;
iii) identify an exit point, and from the exit point, generate a point that is a vector lying inside a nearby stability region of a corresponding stable equilibrium point;
iv) starting from the point generated in step (c)(iii), apply the local optimization method to find a corresponding set of tier-1 local optimal solutions;
v) using the set of tier-1 local optimal solutions, continue to apply the local optimization method to find the set of tier-2 local optimal solutions;
vi) repeat the method from step (c)(i) if the set of tier-1 and tier-2 local optimal solutions has not been found; and
vii) identifying a best local optimal solution from the tier-0, tier-1 and tier-2 local optimal solutions as the global optimal solution.

21. The method of claim 20, in which the local optimization method is a quasi-Newton method.

22. The method of claim 20, in which the metaheuristic method is a genetic algorithm method.

23. The method of claim 20, in which the metaheuristic method is a particle swarm optimization method.

24. A method of short-term load forecasting in a power system using an artificial neural network having an objective function, the method comprising the steps of:
a) training the artificial neural network by finding a global optimal solution to an optimization problem for finding best weights to minimize mean squared error between forecast outputs and actual loads, comprising:
i) preparing a historical dataset comprising historical input data and historical output data for each day over a period of time;
ii) evaluating the objective function associated with a solution by
A) assigning the solution, which is a parameter vector, to the neural network;
B) applying the historical input data to the neural network to produce a forecast dataset for each day of the period of time; and
C) comparing the forecast dataset to the historical dataset for the period of time and computing the mean square error;
iv) finding a global optimal parameter vector for the artificial neural network by the steps of:
A) exploration and consensus by metaheuristic methods comprising:
i) solving the optimization problem (10) using a metaheuristic method;
ii) organizing search instances as clusters of particles;
iii) repeating the metaheuristic method from step (a)(ii) until a stopping criterion is met.
B) guiding local methods with representative points, comprising:
i) selecting a center and best particles from each cluster of particles;
ii) starting from the center and best particles, using a local method to search for a tier-0 local optimal solution to the optimization problem (10) for each cluster of particles; and
C) starting with the local optimal solutions for the clusters of particles, exploiting the search space using a TRUST-TECH methodology, comprising:
i) computing eigenvectors of the objective Hessian for each of the tier-0 local optimal solutions;
ii) for each of the eigenvectors, move away from the tier-0 local optimal solution;
iii) identify an exit point, and from the exit point, generate a point that is a vector lying inside a nearby stability region of a corresponding stable equilibrium point;
iv) starting from the point generated in step (c)(iii), apply the local optimization method to find a corresponding set of tier-1 local optimal solutions;
v) using the set of tier-1 local optimal solutions, continue to apply the local optimization method to find the set of tier-2 local optimal solutions;
vi) repeat the method from step (iv)(C)(i) if the set of tier-1 and tier-2 local optimal solutions has not been found; and
vii) identifying a best local optimal solution from the tier-0, tier-1 and tier-2 local optimal solutions as the global optimal solution; and
iv) assigning the global optimal solution, which is a parameter vector, to the artificial neural network and the resulting artificial neural network is the trained artificial neural network; and
b) applying the trained artificial neural network to a real-time environment to produce load forecasts, the applied neural network using as an input a real-time input data set and producing an output data set representing a load forecast for a next period.

25. The method of claim 24, in which the historical input data comprises periodic measurements of load in the power system and at least one item of climate data over a selected period of time,

26. The method of claim 24, in which the at least one item of climate data is selected from a group consisting of temperature, humidity, weekday or holiday.

27. The method of claim 24, in which the historical output data comprises 24-hour load forecasts.

28. The method of claim 24, wherein the local method is a backpropagation method.
